(19) United States
(12) Patent Application Publication
(10) Pub. No.: US 2016/0371796 A1
(43) Pub. Date: Dec. 22, 2016

(54) TRANSACTIVE CONTROL SYSTEMS WITH ENHANCED CONVERGENCE BEHAVIOR

(71) Applicant: Battelle Memorial Institute, Richland, WA (US)

(72) Inventor: David P. Chassin, Pasco, WA (US)

(73) Assignee: Battelle Memorial Institute, Richland, WA (US)

(21) Appl. No.: 15/168,518

(22) Filed: May 31, 2016

Related U.S. Application Data
(60) Provisional application No. 62/181,759, filed on Jun. 18, 2015.

(51) Int. Cl. G06Q 50/06; G06Q 40/04; G06Q 50/18

(52) U.S. Cl. CPC G06Q 50/06; G06Q 50/188; G06Q 40/04

(57) ABSTRACT

Disclosed herein are exemplary embodiments of methods and systems that can be used to implement transactive control schemes for use in distributed transactive control power distribution systems. Embodiments of the disclosed technology include design methodologies that can be used to identify utility negotiation strategies that guarantee price-discovery in a finite time. Exemplary auctionless price discovery methods utilize a convergence acceleration factor that reduces the number of iterations between a supplier and a consumer transactive controller that are needed to reach agreement on an mutually acceptable price and quantity of electricity to transfer from the electricity supplier to the electricity consumer.

### CROSS-REFERENCE TO RELATED APPLICATIONS

This application claims the benefit of U.S. Provisional Patent Application No. 62/181,759, filed Jun. 18, 2015, entitled “TRANSACTIVE CONTROL SYSTEMS WITH ENHANCED CONVERGENCE BEHAVIOR,” which is incorporated by reference herein in its entirety.

### ACKNOWLEDGMENT OF GOVERNMENT SUPPORT

This invention was made with government support under DE-AC05-76RL01830 awarded by the U.S. Department of Energy. The government has certain rights in the invention.

### FIELD

This application relates generally to the field of power grid management and control.

### SUMMARY

Disclosed below are representative embodiments of methods, apparatus, and systems for facilitating operation and control of a resource distribution system (such as a power grid). Among the disclosed embodiments herein are techniques that enable distributed smart grid assets to effectively contribute to grid operations in a controllable manner, while helping to ensure system stability

Disclosed herein are example embodiments of mechanisms that can be used to implement transactive control schemes for use in distributed transactive control power distribution systems. Embodiments of the disclosed technology include design methodologies that can be used to identify utility negotiation strategies that guarantee price-discovery in a finite time. Example price negotiation strategies for use in a transactive control environment are disclosed and numerical results presented showing that they converge rapidly.

More specifically, example embodiments of a linear price-discovery mechanism for utilities are disclosed that seek to implement indirect load control paradigms like transactive control. Examples of the mechanism can be implemented as an iterative price-negotiation strategy. Certain implementations lead to convergence in at most two iterations when the demand curve is known. Further, with particular implementations, convergence is guaranteed to be always stable even when the demand curve is not known precisely. The embodiments and results disclosed herein support a tenet of indirect load control paradigms in general, and transactive control paradigms in particular: that both auction-based and iterative price-discovery mechanisms can be employed with successful (and even equivalent) results as part of larger more complex control systems and contribute to the closed-loop stability of these systems.

Embodiments of the disclosed methods can be performed using computing hardware, such as a computer processor or an integrated circuit. For example, embodiments of the disclosed methods can be performed by software stored on one or more non-transitory computer-readable media (e.g., one or more optical media discs, volatile memory components (such as DRAM or SRAM), or nonvolatile memory or storage components (such as hard drives or solid state drives (e.g., solid state drives based on flash memory)). Such software can be executed on a single computer or on a networked computer (e.g., via the Internet, a wide-area network, a local-area network, a client-server network, a cloud-based network, or other such network). Embodiments of the disclosed methods can also be performed by specialized computing hardware (e.g., one or more application specific integrated circuits (ASICs) or programmable logic devices (such as field programmable gate arrays (FPGAs)) configured to perform any of the disclosed methods). Additionally, any intermediate or final result created or modified using any of the disclosed methods can be stored on a non-transitory storage medium (e.g., one or more optical media discs, volatile memory or storage components (such as DRAM or SRAM), or nonvolatile memory or storage components (such as hard drives)) and are considered to be within the scope of this disclosure. Furthermore, any of the software embodiments (comprising, for example, computer-executable instructions which when executed by a computer cause the computer to perform any of the disclosed methods), intermediate results, or final results created or modified by the disclosed methods can be transmitted, received, or accessed through a suitable communication means.

The foregoing and other objects, features, and advantages of the invention will become more apparent from the following detailed description, which proceeds with reference to the accompanying figures.

### BRIEF DESCRIPTION OF THE DRAWINGS

FIGS. 1A and 1B show logistic map iteration sequences of price discovery mechanisms for example stable (1A) and unstable (1B) negotiation systems.

FIG. 2 is a block diagram showing a strategy with quantity constraint tracking in accordance with an embodiment of the disclosed technology.

FIGS. 3A-3C illustrate simulations of stable, marginal, and unstable negotiation strategies stabilized in accordance with embodiments of the disclosed technology.

FIG. 4 is a block diagram showing another strategy with integral error feedback in accordance with an embodiment of the disclosed technology.

FIGS. 5A-5C illustrate simulations similar to those of FIGS. 3A-3C, stabilized with integral error feedback and error in the demand response curve estimate

FIG. 6 is a block diagram illustrating a suitable computing environment in which embodiments of the disclosed techniques can be implemented and which may be used in or in conjunction with a transactive controller.

FIG. 7 is a flow chart illustrating an exemplary method disclosed herein.

FIG. 8 is a schematic diagram illustrating an exemplary system disclosed herein.

### DETAILED DESCRIPTION

### I. General Considerations

Disclosed below are representative embodiments of methods, apparatus, and systems for facilitating operation and control of a resource distribution system (such as a power grid). The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any one or more features or aspects of the disclosed embodiments can be used alone or in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “generate” to describe the disclosed methods. These terms are high-level abstractions of the actual operations that are performed. The actual operations that correspond to these terms may vary depending on the particular implementation and are readily discernible by one of ordinary skill in the art. Furthermore, as used herein, the term “and/or” means any one item or combination of items in the phrase.

Any of the embodiments disclosed herein can be used with and/or incorporated into any of the transactive control schemes and architectures described in U.S. Nonprovisional application Ser. No. 12/587,008 filed on Sep. 29, 2009, and entitled “ELECTRIC POWER GRID CONTROL USING A MARKET-BASED RESOURCE ALLOCATION SYSTEM,” (published as U.S. Patent Application Publication No. 2010/0114387); U.S. Nonprovisional application Ser. No. 12/686,243 filed on Jan. 12, 2010, and entitled “NESTED, HIERARCHICAL RESOURCE ALLOCATION SCHEMA FOR MANAGEMENT AND CONTROL OF AN ELECTRIC POWER GRID” (published as U.S. Patent Application Publication No. 2010/0179862); U.S. Nonprovisional application Ser. No. 13/096,682 filed on Apr. 28, 2011, and entitled “FORWARD-LOOKING TRANSACTIVE PRICING SCHEMES FOR USE IN A MARKET-BASED RESOURCE ALLOCATION SYSTEM”; (published as U.S. Patent Application Publication No. 2012/0278220); U.S. Nonprovisional application Ser. No. 14/108,078 filed on Dec. 16, 2013, and entitled “TRANSACTIVE CONTROL AND COORDINATION FRAMEWORK AND ASSOCIATED TOOLKIT FUNCTIONS” (published as U.S. Patent Application Publication No. 2014/0172503); and U.S. Nonprovisional application Ser. No. 14/145,742 filed on Dec. 31, 2013, and entitled “DISTRIBUTED HIERARCHICAL CONTROL ARCHITECTURE FOR INTEGRATING SMART GRID ASSETS DURING NORMAL AND DISRUPTED OPERATIONS” (published as U.S. Patent Application Publication No. 2014/0188689), all of which are hereby incorporated herein by reference in their entirety.

Any of the disclosed methods can be implemented using computer-executable instructions stored on one or more computer-readable media (e.g., non-transitory computer-readable media, such as one or more optical media discs, volatile memory components (such as DRAM or SRAM), or nonvolatile memory components (such as hard drives)) and executed by a processor in a computing device (e.g., a computer). Any of the computer-executable instructions for implementing the disclosed techniques as well as any intermediate or final data created and used during implementation of the disclosed systems can be stored on one or more computer-readable media (e.g., non-transitory computer-readable media). The computer-executable instructions can be part of, for example, a dedicated software application or as part of a software agent's transport payload that is accessed or downloaded via a network (e.g., a local-area network, a wide-area network, a client-server network, or other such network).

Such software can be executed on a single computer (e.g., a computer embedded in or electrically coupled to a sensor, controller, or other device in the power grid) or in a network environment. For example, the software can be executed by a computer embedded in or communicatively coupled to: a control unit for a home or household appliance or system (e.g., an air-conditioning unit, heating unit, heating-ventilation-and air-conditioning (HVAC) system, hot water heater, refrigerator, dish washer, washing machine, dryer, oven, microwave oven, pump, home lighting system, electrical charger, electric vehicle charger, home electrical system, or any other electrical system having variable performance states), a control unit for a distributed generator (e.g., photovoltaic arrays, wind turbines, or electric battery charging systems), a control unit for controlling the distribution or generation of power along the power grid (e.g., a transformer, switch, circuit breaker, generator, resource provider, or any other device on the power grid configured to perform a control action), a sensor for measuring electrical parameters of a power line, a synchrophasor sensor, a smart meter, and the like. These household appliances and distributed generators are examples of the “electrical devices”, “distributed smart grid assets”, “distributed assets”, or “assets” mentioned below. These devices can be controlled by the computer performing embodiments of the disclosed technology and have their operational states adjusted (e.g., turned on, off, or set to particular performance level) by the computer using appropriate control signals and/or hardware switches. Such a computer (or system using such a computer) that performs embodiments of the disclosed price-discovery mechanisms and controls operation of one or more associated electrical devices (either demand-side devices or supply-side devices) is sometimes referred to herein as a “transactive controller”. In certain example scenarios, one or more demand-side transactive controllers for associated one or more household devices communicate with a central computer (e.g., a supply-side transactive controller) operated by, for example, an electrical utility that serves as the supplier in embodiments discussed below and provides the power to be allocated and distributed (e.g., through the utility's distribution network (including feeders, etc.)).

For clarity, only certain selected aspects of the software-based embodiments are described. Other details that are well known in the art are omitted. For example, it should be understood that the software-based embodiments are not limited to any specific computer language or program. For instance, embodiments of the disclosed technology can be implemented by software written in C++, Java, Perl, JavaScript, Adobe Flash, Python, JINI, .NET, Lua or any other suitable programming language. Likewise, embodiments of the disclosed technology are not limited to any particular computer or type of hardware. Details of suitable computers and hardware are well known and need not be set forth in detail in this disclosure.

Furthermore, any of the software-based embodiments (comprising, for example, computer-executable instructions which when executed by a computer cause the computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods and transactive controllers can also be implemented by specialized computing hardware that is configured to perform any of the disclosed methods and transactive control operations. For example, the disclosed methods can be implemented by a computing device comprising an integrated circuit (e.g., an application specific integrated circuit (ASIC) or programmable logic device (PLD), such as a field programmable gate array (FPGA)). The integrated circuit or specialized computing hardware can be embedded in or directly coupled to a sensor, control unit, or other device in the power grid. For example, the integrated circuit can be embedded in or otherwise coupled to a control unit for a home or household appliance or system, a control unit for a distributed generator, a control unit for controlling power distribution on the grid, a synchrophasor sensor, a smart meter, or other such device.

### II. Embodiments of the Disclosed Technology

A. Introduction

It has been said that demand and not supply is the real opportunity for significant advancement in electricity planning and operations. Several advancements in demand response systems have been made. For example, an embodiment of the system described in U.S. Nonprovisional application Ser. No. 12/587,008 filed on Sep. 29, 2009, and entitled “ELECTRIC POWER GRID CONTROL USING A MARKET-BASED RESOURCE ALLOCATION SYSTEM,” (published as U.S. Patent Application Publication No. 2010/0114387) implemented the first utility-scale retail real-time price market that integrated demand and supply in a feeder-level 5-minute double auction that brought together all the values necessary to make the smart grid vision economically, regulatorily and technically feasible. Since then, other experimental projects have built successfully on that concept and shown the robustness and potential of transactive systems. However, for some transactive control systems, certain issues have arisen that present opportunity for improvement.

Short term demand response is often divided into two basic categories, directly dispatchable and indirectly dispatchable. In the case of directly dispatchable demand response, control of the load is relinquished by the consumer and direct control is assumed by the utility only when demand response is needed. Among other things, this approach has the advantage of providing the utility with greater certainty about the magnitude of the response to a load control signal. However, consumer concerns about autonomy and comfort impacts on peak days often limits the available resource. In addition, there are sometimes concerns about program sustainability at high levels because of “free-rider” consumers who sign up for these demand response programs to benefit from the discounted energy rate incentives without providing the additional resource. These customers either already provide the benefit without compensation or opt out of the program as soon as it starts getting used too much.

Indirect dispatch systems use incentive signals, such as real-time prices to “call” demand response. Most of these systems use day-ahead price signals. Faster-acting 5-minute real-time pricing was also demonstrated successfully in several experimental projects. However, in all such systems, computing the incentive signal to be dispatched can be a challenge. In particular, price feedback systems may be unstable. In the case of the 5-minute real-time pricing system, a retail double auction was used in which consumer bid prices above which they would forgo consumption for the next five minutes. The advantage of using auctions is that by eliminating the time delay in the feedback, a significant source of the system instability is mitigated.

However, auction-based price discovery mechanisms are not always feasible or desirable. In certain systems, an iterative price-discovery approach is used as an alternative to the auction-based mechanisms.

The disclosed technology generally concerns technical considerations regarding negotiated price-discovery mechanisms when applied to demand-response dispatch problems. Among the issues addressed is how a transactive controller can compute the fast-acting indirect demand dispatch (the incentive signal used to achieve a particular level of demand response). The basis for a real-time negotiation-based price-discovery mechanism is also addressed and example approaches for ensuring that such mechanisms robustly and reliably find the retail price at which supply will equal demand are disclosed.

The example mechanisms as disclosed herein can be incorporated for use in any suitable transactive control system, including embodiments of the negotiation-based systems described in U.S. Nonprovisional application Ser. No. 14/108,078 filed on Dec. 16, 2013, and entitled “TRANSACTIVE CONTROL AND COORDINATION FRAMEWORK AND ASSOCIATED TOOLKIT FUNCTIONS” (published as U.S. Patent Application Publication No. 2014/0172503), embodiments of the transactive control systems described in the patent applications referenced above in Section I, or in embodiments of any other suitable transactive control system.

Further, it should be understood that the disclosed methods, systems, and apparatus can be adapted for application to systems with multiple demand-side transactive controllers, multiple supply-side transactive controllers, or systems in which multiple supply-side transactive controllers and multiple demand-side transactive controllers operate together. All such methods, systems, and apparatus are considered to be within the scope of the disclosed technology.

B. Transactive Price Discovery

In this section, technical considerations are examined for utilities that wish to dispatch demand response for loads that present responses that are functionally unknown. When this situation arises, utilities employ one of several possible mechanisms to discover the dispatch signal that will satisfy the physical constraints on the system. In this section, one such mechanism is considered with the understanding that the principles and methods apply more broadly to any iterative price-discovery mechanism a utility may wish to employ. One of the main contributions of this section is the derivation of a technique to evaluate limitations on iterative mechanisms used to determine the price at which supply equals demand. This limitation is examined to illustrate how one can use it to design stable real-time price discovery mechanisms for retail electricity markets.

Using arbitrary functional models of supply and demand, one can analytically examine the behavior of iterative price discovery mechanisms used in systems that do not employ auction clearing for price-discovery. A simple iterative price-discovery method is a negotiated price, in which the utility offers an initial hypothetical price p(0) to which potential consumers respond either individually or in the aggregate with a hypothetical quantity q(0). The utility follows up with a second proposed price p(1) to which the consumers respond with a proposed quantity q(1), followed by p(2), q(2) and p(3), q(3) and so on until the utility determines that the process has converged on a price that cannot be changed significantly without increasing the mismatch between supply and demand, or that the process must be stopped due to excessive iteration. In such a process, it is presumed that the functions used by suppliers and consumers to convert quantities to prices and prices to quantities, respectively, are the supply and demand curves, respectively. These curves are not shared in their entirety with the other party, either because they are considered too business-sensitive to reveal (as is often the case with suppliers) or because they are not explicitly known to the party (as is often the case for consumers). The exchange is also presumed to be so limited that neither party can deduce the other's complete curve, while still sufficient to reliably deduce the dispatch price and quantity at which the two curves intersect.

An example iterative price-discovery process can be described using the iterative state equations for quantity and price:

$$q ( k ) = \frac{1}{b} [ p ( k ) - P ] + Q and p ( k + 1 ) - a [ q ( k ) - Q ] + P$$

respectively, where a and b are the slopes of the supply and demand curves, respectively, and P and Q are the clearing price and quantity, respectively to which the negotiation process should converge. When the supply and demand curves are linear functions, the iterative price-discovery process can be defined using a linear discrete-time state-space representation:

$$[ \begin{matrix}p ( k + 1 ) \\ q ( k + 1 )\end{matrix} ] = [ \begin{matrix}0 & a \\ \frac{a}{{b}^{2}} & 0\end{matrix} ] [ \begin{matrix}p ( k ) \\ q ( k )\end{matrix} ]$$

for k=0, 1, 2 . . .
The stability of this iterative price-discovery mechanism is determined by the magnitude of the roots of the system's characteristic equation

$${z}^{2} - \frac{{a}^{2}}{{b}^{2}} = 0.$$

Noting that b<0<a, it can be concluded that the negotiation can converge on the clearing price and quantity only when a<−b.

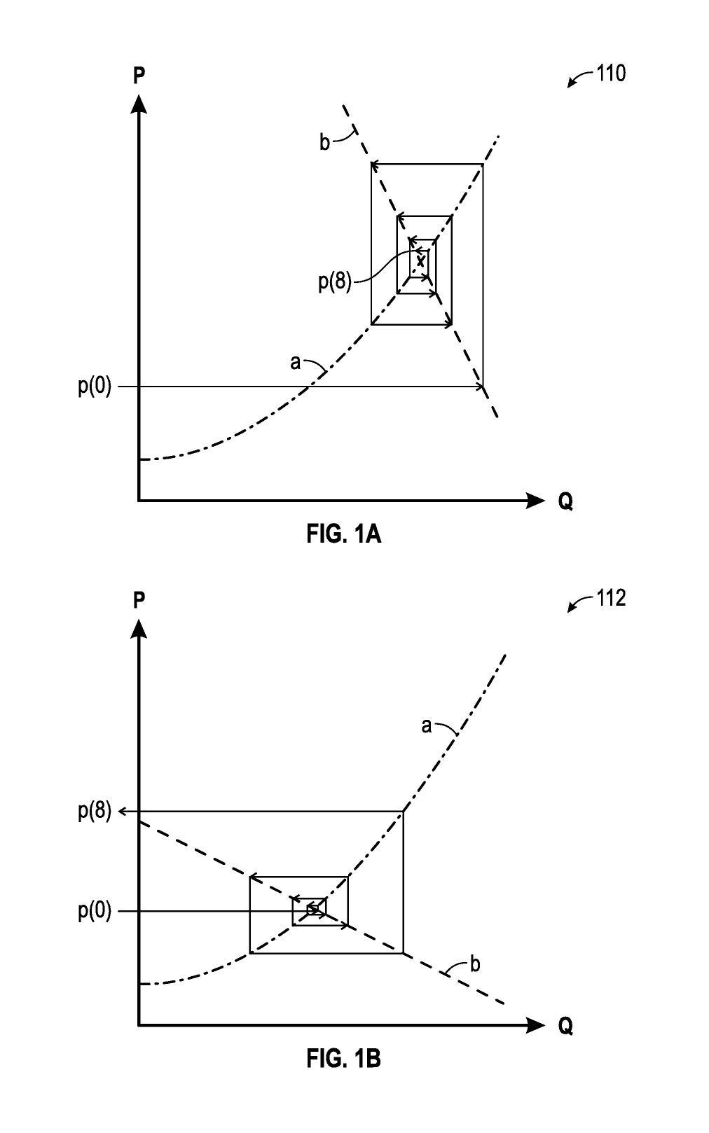

The impact of this stability condition is illustrated in FIGS. 1A and 1B for two different combinations of a and b, one stable (diagram 110, FIG. 1A) and one unstable (diagram 112, FIG. 1B). When the slopes of the upward-sloping supply curve (a) and downward-sloping demand curves (b) in the neighborhood of the clearing price are such that their ratio (a/b) is less than −1, the iterative price discovery mechanism fails to converge on the clearing price and quantity. In particular, FIGS. 1A and 1B show the logistic map iteration sequences of price discovery mechanisms (where the price begins at the price represented by p(0) and converges to the price at p(8) after 8 iterations) in a transactive system for a<−b (diagram 110, FIG. 1A) and a>−b (diagram 112, FIG. 1B).

This stability condition cannot be generally satisfied for all linear supply and demand curves, specifically when supply is very inelastic and/or demand is very elastic. Neither is it expected to be satisfied for any general non-linear curves. Evaluation of whether a non-linear system will be stable can be made by considering the following approximations for the supply and demand responses:

$$\tilde{p} ( k + 1 ) = α {q ( k )}^{2} + β q ( k ) + {P}_{m i n} and \hat{q} ( k ) = {Q}_{U} + {Q}_{R} \frac{p ( k )}{{P}_{ma x}}$$

respectively, in the neighborhood of the clearing price and quantity. This approximation is the canonical quadratic map problem based on the recurrence equation

$${x}_{n} = \frac{1}{2} ( 1 - f ( n ) [ {r}^{n} {f ( x )}^{- 1} ( 1 - 2 {x}_{0} ) ] )$$

where f(n) is the time-domain solution function and f(x)⁻¹ is its inverse. This system is known to be meta-stable (it has no single fixed solution point xₙ) for values of r>3:5, and chaotic for values of r>4, with closed-form solutions to f known only for

r ∈ {−2,2,4}.

To determine the stability of a linear negotiated market clearing mechanism when the supply and demand curves are not linear functions, the joint spectral radius for the linearized state space representation can be evaluated:

$$[ \begin{matrix}p ( k + 1 ) \\ q ( k + 1 )\end{matrix} ] = \underbrace{[ \begin{matrix}0 & A ( q ( k ) ) \\ \frac{A ( q ( k ) )}{{B}^{2} ( p ( k ) )} & 0\end{matrix} ]}_{G} [ \begin{matrix}p ( k ) \\ q ( k )\end{matrix} ]$$

where (A, B) ∈ G (A;B) are the first order terms of the Taylor expansions

$$\{ \begin{matrix}P ( x - q ) = P ( q ) + \underbrace{{P}^{′} ( q )}_{A ( q )} ( x - q ) + \frac{1}{2} {P}^{″} ( q ) {( x - q )}^{2} + … \\ Q ( y - p ) = Q ( p ) + \underbrace{{Q}^{′} ( p )}_{B ( p )} ( y - p ) + \frac{1}{2} {Q}^{″} ( p ) {( y - p )}^{2} + …\end{matrix}$$

of the demand and supply curves about the price and quantity at the iteration k, respectively. Such a system is only stable when the mean spectral radius ρ(G)<1.

Thus, it can be said that for systems with small amounts of demand response and typical supply curves, convergence can be expected when the supply and demand elasticities at the clearing price and quantity are such that −B(P_{c})<A(Q_{c}). If this is not true, the negotiation will converge only to a boundary region outside of which this condition is satisfied because within that region the process diverges. If the clearing price and quantity are inside the divergence region, then they cannot be discovered by the simple linear negotiation strategy described above.

In the case of logistic demand curves observed in certain experimental transactive systems, convergence is possible only when

$${η}_{D} > - \frac{1}{{η}_{S}} {( \frac{{P}_{c}}{{Q}_{c}} )}^{2} \qquad ( 1 )$$

where η_{S} and η_{D} are the supply and demand elasticities at the clearing price, respectively. This limits the conditions for which convergence is possible when using linear negotiation strategies to only relatively inelastic demand curves in the neighborhood of the clearing price and quantity. The more elastic supply is, the less elastic demand must be for the negotiation to successfully converge on a price at which supply will equal demand. As has been observed in field experimental data, high demand elasticities do occur during period of constrained supply conditions. This is why simple linear iterative negotiated price-discovery mechanisms exhibit certain shortcomings for price-based demand response dispatch systems such as those used for transactive control.

C. Stable Mechanism Design

Insights gained from the analysis above can be used to devise a price discovery mechanism using an enhanced negotiating strategy for the utility that will satisfy its objective of quickly finding a price at which supply equals demand without changing the final price and quantity discovered. In certain embodiments of the disclosed technology, the utility's second proposed price in response to the consumer's initial proposed quantity is augmented with a term that includes the last proposed price, such that

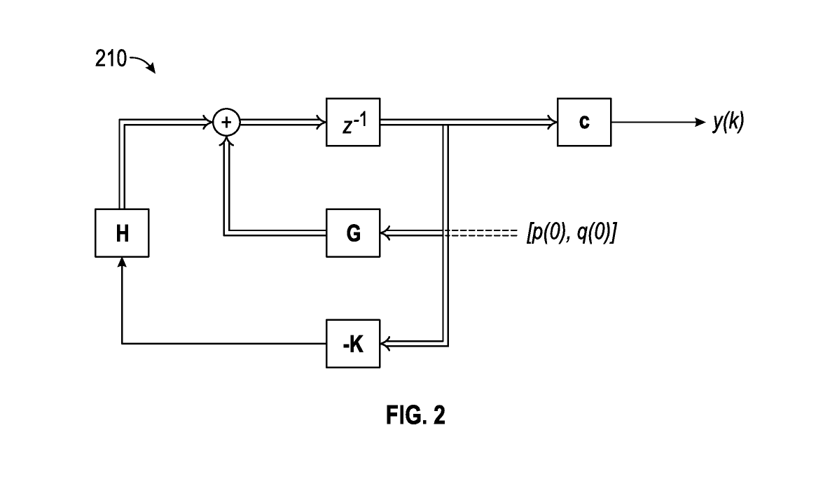

p(k+1)=[c−kₚ]p(k)+[a−k_{q}]q(k)

where c is a proportional coefficient for the previous price, and K=[kₚ, k_{q}] are feedback coefficients that are used to tune the relative input of the previous price and quantity. The design of this example system is illustrated in diagram 210 of FIG. 2 and the statespace representation of this advanced negotiation strategy for any reference quantity input r(k) is

$$[ \begin{matrix}p ( k + 1 ) \\ q ( k + 1 )\end{matrix} ] = {\underbrace{[ \begin{matrix}c & a \\ \frac{a}{{b}^{2}} + c & 0\end{matrix} ]}}_{G} [ \begin{matrix}p ( k ) \\ q ( k )\end{matrix} ] - \underbrace{[ \begin{matrix}1 \\ \frac{1}{b}\end{matrix} ]}_{H} {\underbrace{[ \begin{matrix}{k}_{p} & {k}_{q}\end{matrix} ]}}_{K} [ \begin{matrix}p ( k ) \\ q ( k )\end{matrix} ] \qquad ( 2 )$$

with the output quantity

$$y ( k ) = {\underbrace{[ \begin{matrix}0 & 1\end{matrix} ]}}_{c} [ \begin{matrix}p ( k ) \\ q ( k )\end{matrix} ] .$$

In particular, FIG. 2 illustrates an advanced negotiation strategy diagram 210 with quantity constraint tracking in accordance with an embodiment of the disclosed technology.

The negotiation strategy design problem for the utility is then reduced to determining the value K such that negotiation converges as quickly as possible (or converges at another desirable rate) on the price at which supply equals demand. In certain example implementations, this “deadbeat” system response involves the characteristic equation being reduced to z²=0, a condition which can be obtained when

$$K = [ c - \frac{{a}^{2}}{{b}^{2} c ( b - 1 )} - \frac{a}{b} , a + \frac{{a}^{2}}{bc ( b - 1 )} ] . \qquad ( 3 )$$

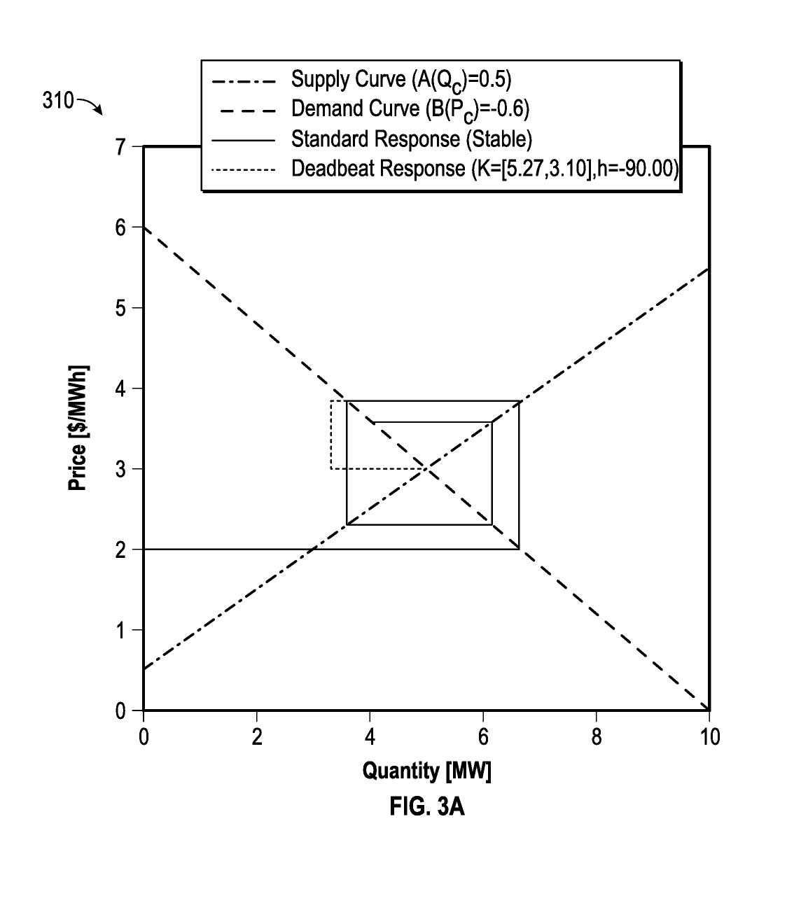

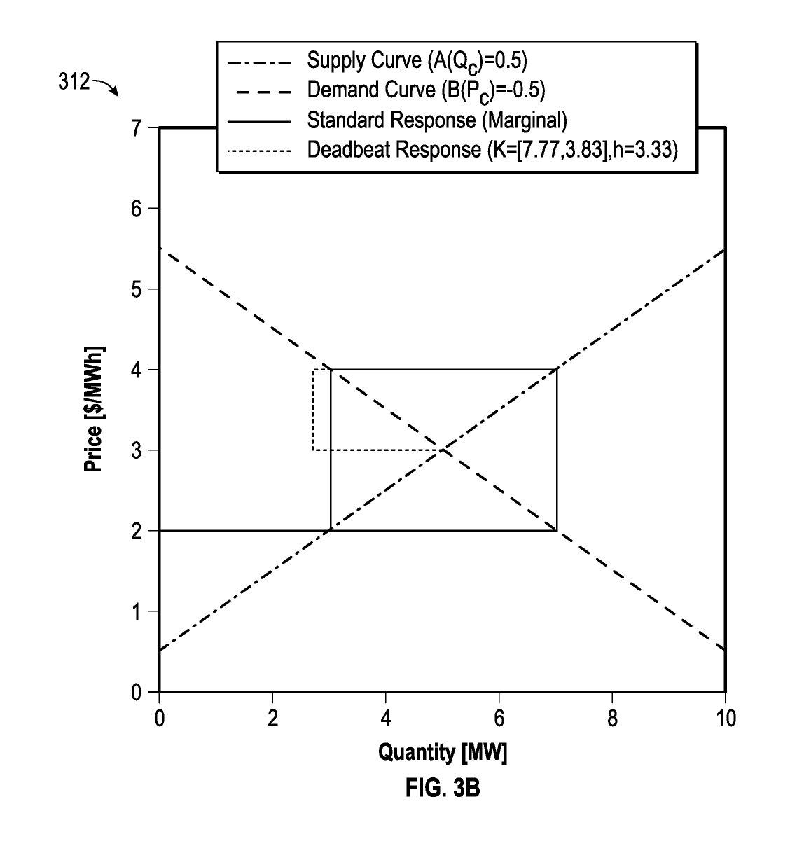

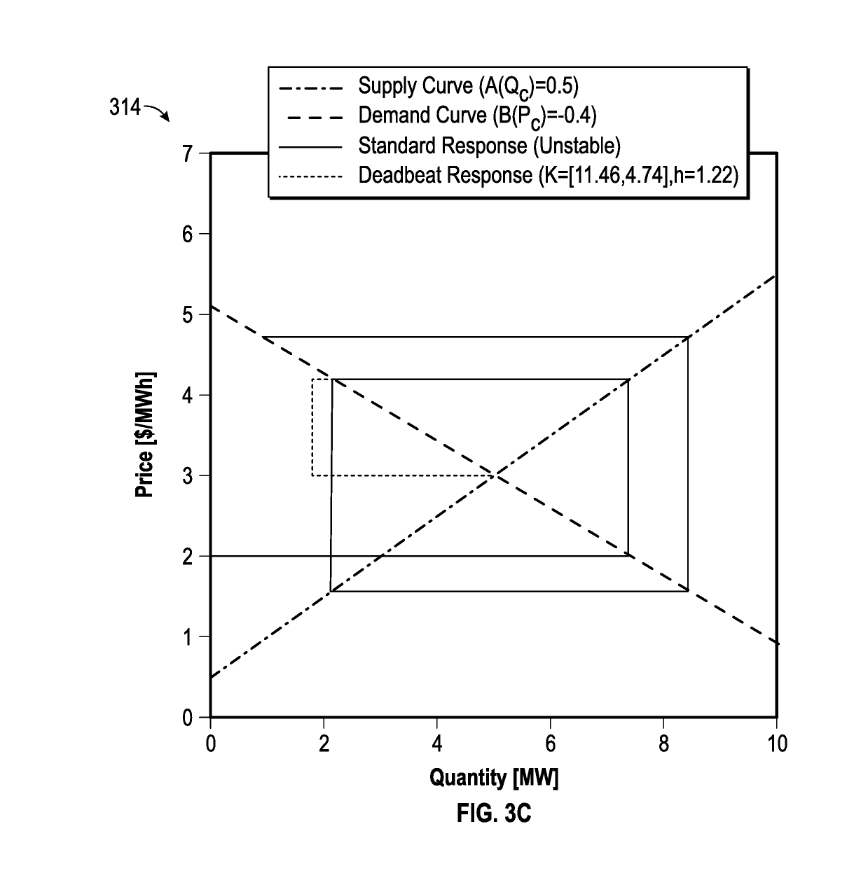

Examples for three different levels of demand response are shown in diagrams 310, 312, 314 of FIGS. 3A-3C, where the demand curve has been linearized in the neighborhood of the clearing price and quantity, as described above. In particular, FIGS. 3A-3C illustrate simulations of stable (diagram 310, FIG. 3A), marginal (diagram 312, FIG. 3B) and unstable (diagram 314, FIG. 3C) negotiations without and with corresponding deadbeat negotiation strategies. In all three cases, the deadbeat negotiating strategy converges in two iterations to the clearing price and quantity, outperforming the simple linear negotiation strategy for even the stable case (FIG. 3A). More significantly the deadbeat strategy converges when the simple strategy fails to converge (FIG. 3C).

1. Demand Response Uncertainty

In Equation (3), the slope of the demand curve b is included in the computation of the negotiation strategy parameters of K. Uncertainty in b can result in an error in the clearing price and quantity. The demand curve may not be known exactly or it may change from time to time. The utility may wish to employ an enhanced negotiation strategy to reduce the clearing price error that may result from inaccurate estimation of this demand curve parameter b.

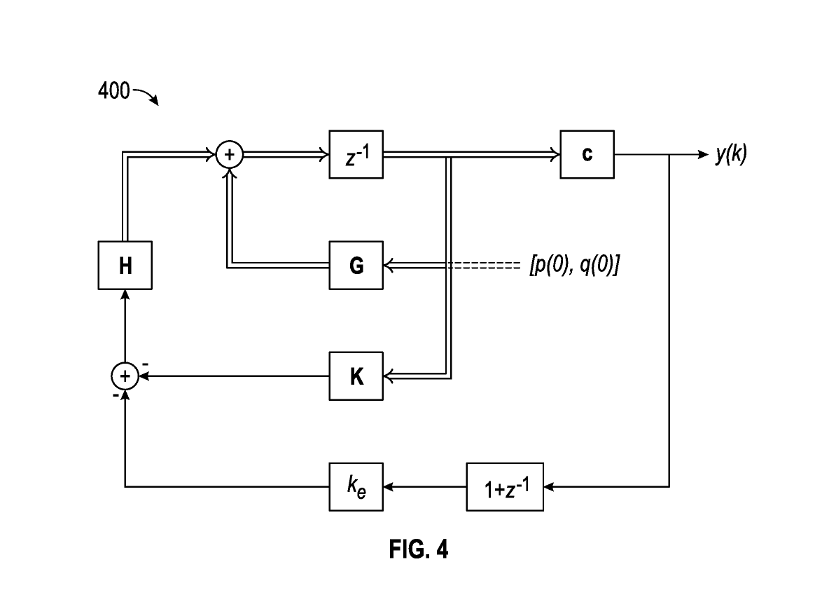

A further design consideration that can be used in certain embodiments of the disclosed technology is to compensate for the unknown demand function by implementing integral error feedback in the negotiation process. This approach adds a third state to the state-space representation in Equation (2). This new state represents the accumulated error between the most recent quantity from the consumer(s) and the clearing quantity. This error is then multiplied by a gain kₑ and the result is added to the price response p(k+1). This approach raises the overall order of the system by one and can be expected to decrease the convergence rate compared to the deadbeat negotiation. But integral error feedback has the significant advantage that it compensates for constant errors in the system (e.g., all constant errors), not just demand elasticity estimation errors. The same method used to find K above can be used in this case to find the joint feedback gains [K, kₑ] required to obtain the fastest possible convergence using a linear negotiation. The behavior of this price-discovery mechanism is illustrated in FIG. 4. In particular, FIG. 4 is a discrete-time system diagram 400 of the advanced negotiation strategy diagram with demand curve uncertainty.

The solution for [K, kₑ] using this approach can be found given any reasonable assumption for the value of b. Choosing a value of \hat{b}=−1 gives the solution for the feedback gains

$${k}_{p} = 1 , {k}_{q} = a + \frac{1}{a} , and {k}_{e} = \frac{1}{a} , . \qquad ( 4 )$$

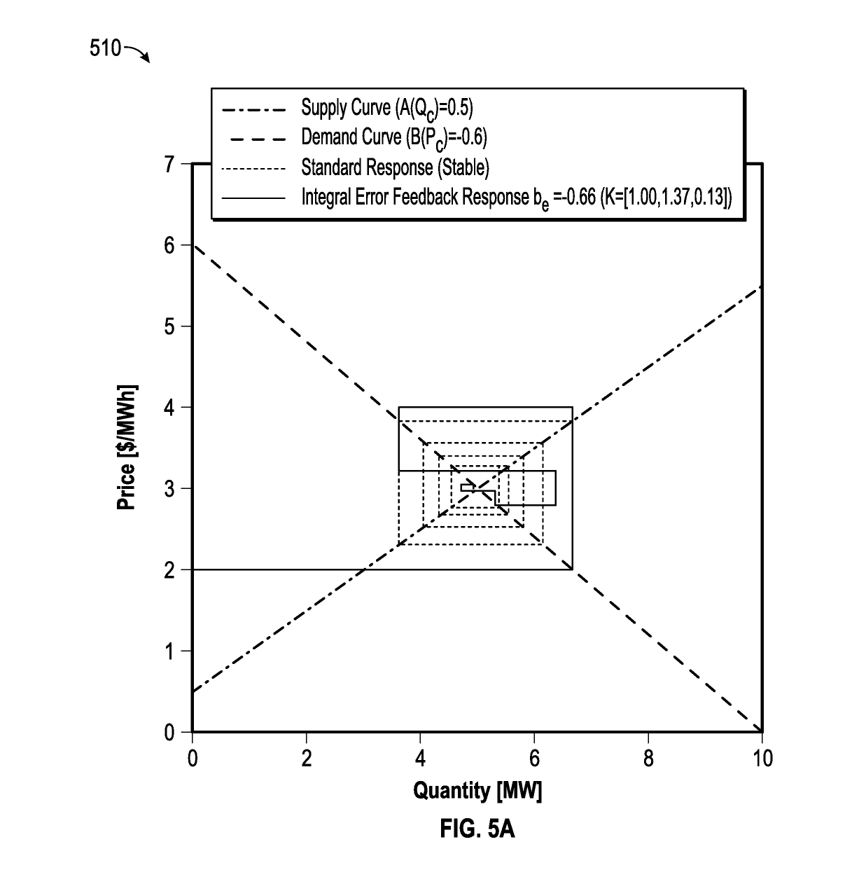

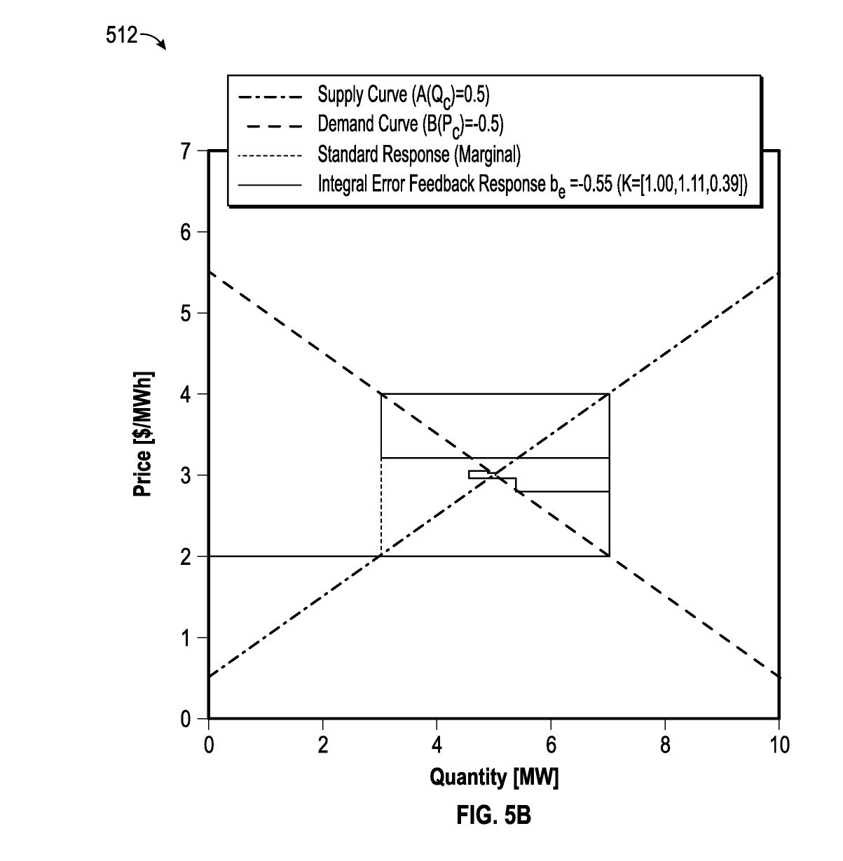

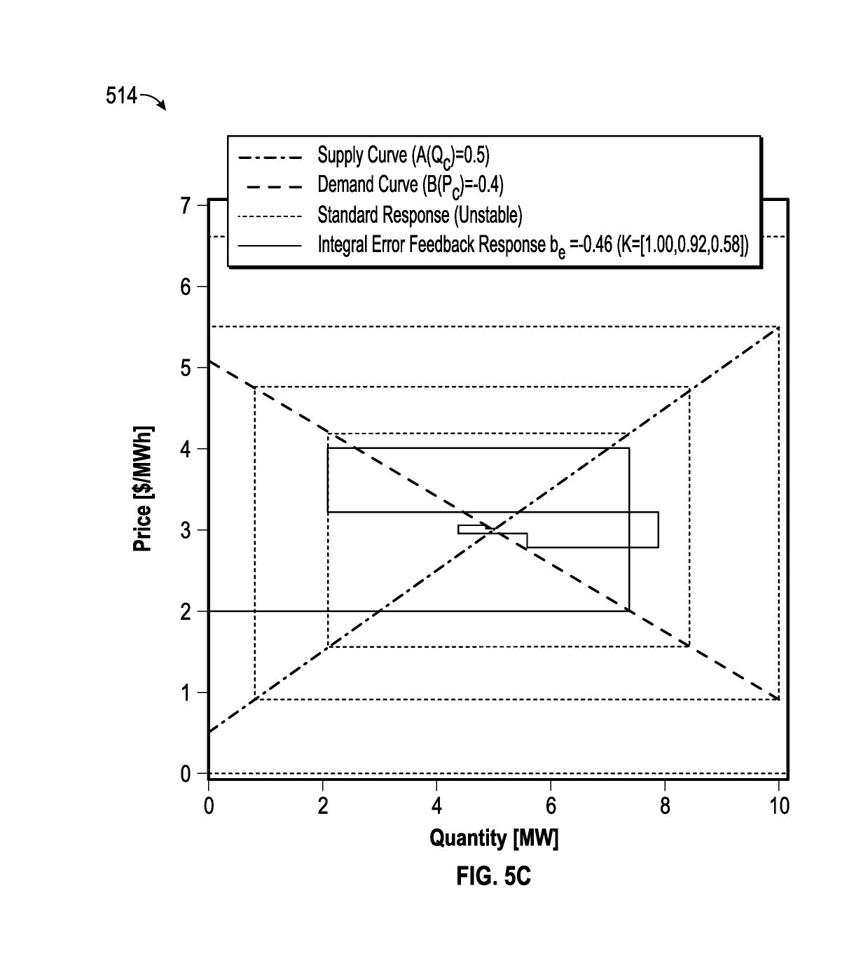

The general solution for the augmented state approach is

$${k}_{p} = 1 , {k}_{q} = a + \frac{{b}^{2}}{a} , and {k}_{e} = 1 - \frac{{b}^{2}}{a}$$

where \hat{b} is the utility's estimate for the slope b of the demand response curve, as illustrated in FIG. 4. In particular, FIGS. 5A-5C include diagrams 510, 512, 514 illustrating an integral error feedback negotiation strategy for the same cases as FIGS. 3A-3C with a +10% error, for example, in the demand response curve estimate \hat{b}. The general solution can be expressed in terms of a utility's price negotiation strategy as

$$p ( k + 1 ) = p ( k ) + ( 2 a + 1 ) q ( k ) + ( 1 - \frac{{\hat{b}}^{2}}{a} ) {\sum }_{j = 1}^{k - 1} q ( j )$$

which will converge in a finite time when b<0<a but with no particular restriction on the relative magnitudes of a and b.

The closed-loop stability of this solution depends on the magnitude of the error in the estimate of \hat{b}. Specifically, the characteristic equation of this price-discovery solution is

$$z ( {z}^{2} - 1 + \frac{{\hat{b}}^{2}}{{b}^{2}} )$$

which suggests that convergence is guaranteed when

\sqrt{2}b<\hat{b}<0. (5)

The constraint that the magnitude \hat{b} cannot be more than about 40% greater than b is a generally reasonable one for the slope of the demand curve in the neighborhood of the solution price and quantity.

D. Detailed Discussion

The dependence of deadbeat negotiation strategy on the utility's knowledge of the demand curve slope b indicates that the clearing price can be computed using a parametric fit of the demand curve from a very large set of bids instead of negotiating with all the loads individually. Instead of performing an auction clearing, the utility can use embodiments of the disclosed technology to indirectly determine the price at which supply equals demand by computing what the negotiation would produce given the demand curve imputed by the bids without actually performing the negotiation. Example embodiments of this method assume that the demand curve fits a mathematical function of some type that can be expected to represent the loads' collective behavior most of the time. For example, the demand curve may generally take the form of a logistic function as observed during quiescent periods in experimental projects. This function has the form

Q=(1+e^{α+βP})⁻¹Q_{R}+Q_{U}

where α is the unobservable component of the demand response behavior and β is the observable component. The parameters can be estimated using the logistic regression

$$α = \overline{P} - β \overline{Q}$$

$$and$$

$$β = \frac{\overline{PQ} - \overline{P} \overline{Q}}{\overline{{P}^{2}} - {\overline{P}}^{2}} .$$

Given such a fit we can estimate the slope of the demand curve at the clearing price

$$\hat{b} = - \frac{β {Q}_{R} {e}^{α + β P}}{{( {e}^{α + β P} + 1 )}^{2}} ,$$

a value that can be readily used to compute the clearing price without performing the full market clearing procedure.

In standard control theory, a non-zero reference quantity r(k) is included in Equation (2). This term merits further discussion because it can be used by the utility to change the quantity that the negotiation will converge to. However, this quantity does not necessarily converge on a price at which supply will equal demand. Non-equilibrium values of r(k) may be theoretically interesting to investigate, but they likely do not have physical meaning that is useful unless the utility intentionally wishes to increase or decrease the load for some operational reason. Generally such deliberate manipulation of the negotiation strategy should be regarding with skepticism, particularly if the result would be an economically inefficient price or a power imbalance that results in operational reliability concerns.

Standard control theory also suggests that when using the integral error feedback negotiation strategy, a better estimate \hat{b} of the demand response slope b results in a faster convergence for the negotiation. But the process will always converge regardless of the error. Here again, collecting real-time demand data from customers can contribute to significantly improving the performance of the price-discovery mechanism by providing information needed to obtain a sufficiently accurate estimate of the demand curve slope.

E. Derivations for Selected Equations

1. Derivation of Equation (1)

One has from the stability condition −b<a the same for a linearization about the clearing price and quantity, or

−B(P_{C})<A(Q_{C})

which in terms of the first-order Taylor expansions of the supply and demand curves is given as

−Q′(P_{C})<P′(Q_{C}).

Based on the definitions of supply and demand elasticity

$${η}_{S} = \frac{{P}_{C}}{{Q}_{C}} \frac{1}{{P}^{′} ( {Q}_{C} )} and {η}_{D} = \frac{{P}_{C}}{{Q}_{C}} {Q}^{′} ( {P}_{C} )$$

the following can be obtained

$$- \frac{{Q}^{′} ( {P}_{C} )}{{P}^{′} ( {Q}_{C} )} = - {η}_{S} {η}_{D} \frac{{Q}_{C}^{2}}{{P}_{C}^{2}} < 1$$

$$or$$

$${η}_{D} > - \frac{1}{{η}_{S}} \frac{{P}_{C}^{2}}{{Q}_{C}^{2}} .$$

2. Derivation of Equation (3)

The system's characteristic equation is

$$a ( z ) = {z}^{2} - cz - \frac{{a}^{2}}{{b}^{2}} - a c$$

so the pole placement matrix is

$$a = [ - c , - a c - \frac{{a}^{2}}{{b}^{2}} ) ]$$

The controllability matrix is

$$c = [ \begin{matrix}1 & \frac{a}{b} + c \\ \frac{1}{b} & \frac{a}{{b}^{2}} + c\end{matrix} ]$$

with determinant

$$\frac{( b - 1 ) c}{b}$$

and inverse

$${c}^{- 1} = [ \begin{matrix}\frac{a + {b}^{2} c}{bc ( b - 1 )} & - \frac{a + bc}{c ( b - 1 )} \\ - \frac{1}{c ( b - 1 )} & \frac{b}{( b - 1 ) c}\end{matrix} ]$$

The Toeplitz matrix is

$$\overline{A} = [ \begin{matrix}1 & 0 \\ - c & 1\end{matrix} ]$$

so its inverse transpose is

$${\overline{A}}^{- T} = [ \begin{matrix}1 & c \\ 0 & 1\end{matrix} ] .$$

The design matrix product is

$${\overline{A}}^{- T} {c}^{- 1} = [ \begin{matrix}1 + \frac{a}{bc ( b - 1 )} & - \frac{a}{c ( b - 1 )} \\ - \frac{1}{c ( b - 1 )} & \frac{b}{( b - 1 ) c}\end{matrix} ]$$

and the gains are therefore

$$\begin{matrix}K = - a {\overline{A}}^{- T} {C}^{- 1} \\ = [ - \frac{a}{b} + c - \frac{{a}^{2}}{{b}^{2} c ( b - 1 )} , a + \frac{{a}^{2}}{bc ( b - 1 )} ] .\end{matrix}$$

3. Derivation of Equation (4)

The augmented system input matrix is

$$H = [ \begin{matrix}1 \\ 0 \\ 0\end{matrix} ]$$

so the augmented state transition matrix is

$$\tilde{G} = [ \begin{matrix}G & H \\ - C & 1\end{matrix} ] = [ \begin{matrix}0 & a & 1 \\ \frac{a}{{b}^{2}} & 0 & 0 \\ 0 & - 1 & 1\end{matrix} ]$$

The characteristic equation of this system is

$$a ( z ) = {z}^{3} - {z}^{2} - \frac{{a}^{2}}{{b}^{2}} z + \frac{a ( a + 1 )}{{b}^{2}} .$$

so the pole placement matrix is

$$a = [ - 1 , - \frac{{a}^{2}}{{b}^{2}} , \frac{a ( a + 1 )}{{b}^{2}} ] .$$

The controllability matrix is

$$c = [ \begin{matrix}1 & 0 & \frac{{a}^{2}}{{b}^{2}} \\ 0 & \frac{a}{{b}^{2}} & 0 \\ 0 & 0 & - \frac{a}{{b}^{2}}\end{matrix} ]$$

with determinant

$$- \frac{{a}^{2}}{{b}^{4}}$$

and inverse

$${c}^{- 1} = [ \begin{matrix}1 & 0 & a \\ 0 & \frac{{b}^{2}}{a} & 0 \\ 0 & 0 & - \frac{{b}^{2}}{a}\end{matrix} ] .$$

The Toeplitz matrix is

$$\overline{A} = [ \begin{matrix}1 & 0 & 0 \\ - 1 & 1 & 0 \\ - \frac{{a}^{2}}{{b}^{2}} & - 1 & 1\end{matrix} ]$$

with inverse transpose

$${\overline{A}}^{- T} = [ \begin{matrix}1 & 1 & 1 + \frac{{a}^{2}}{{b}^{2}} \\ 0 & 1 & 1 \\ 0 & 0 & 1\end{matrix} ] .$$

The design matrix product

$${\overline{A}}^{- T} {c}^{- 1} = [ \begin{matrix}1 & \frac{{b}^{2}}{a} & \frac{{b}^{2}}{a} \\ 0 & \frac{{b}^{2}}{a} & - \frac{{b}^{2}}{a} \\ 0 & 0 & - \frac{{b}^{2}}{a}\end{matrix} ]$$

and the gain matrix is therefore

$$K = - a {\overline{A}}^{- T} {c}^{- 1} = [ 1 , a + \frac{{b}^{2}}{a} , 1 - \frac{{b}^{2}}{a} ] .$$

4. Derivation of Equation (5)

For the closed-loop integral error feedback price-discovery mechanism we have

$$G = [ \begin{matrix}0 & a & 1 \\ \frac{a}{{b}^{2}} & 0 & 0 \\ 0 & - 1 & 1\end{matrix} ] H = [ \begin{matrix}1 \\ 0 \\ 0\end{matrix} ] K = {[ \begin{matrix}1 \\ a + \frac{{\hat{b}}^{2}}{a} \\ 1 - \frac{{\hat{b}}^{2}}{a}\end{matrix} ]}^{T} .$$

The characteristic polynomial for the closed-loop system is obtained from

$$\begin{matrix}det ( zI - G + HK ) = det [ \begin{matrix}z + 1 & \frac{{\hat{b}}^{2}}{a} & - \frac{{\hat{b}}^{2}}{a} \\ - \frac{a}{{b}^{2}} & z & 0 \\ 0 & 1 & z - 1\end{matrix} ] \\ = z ( {z}^{2} - 1 + \frac{{\hat{b}}^{2}}{{b}^{2}} ) .\end{matrix}$$

From this, the stability constraint can be found as

$$\frac{{\hat{b}}^{2}}{{b}^{2}} < 2.$$

Given that b<0, it follows that

### III. Example Embodiments

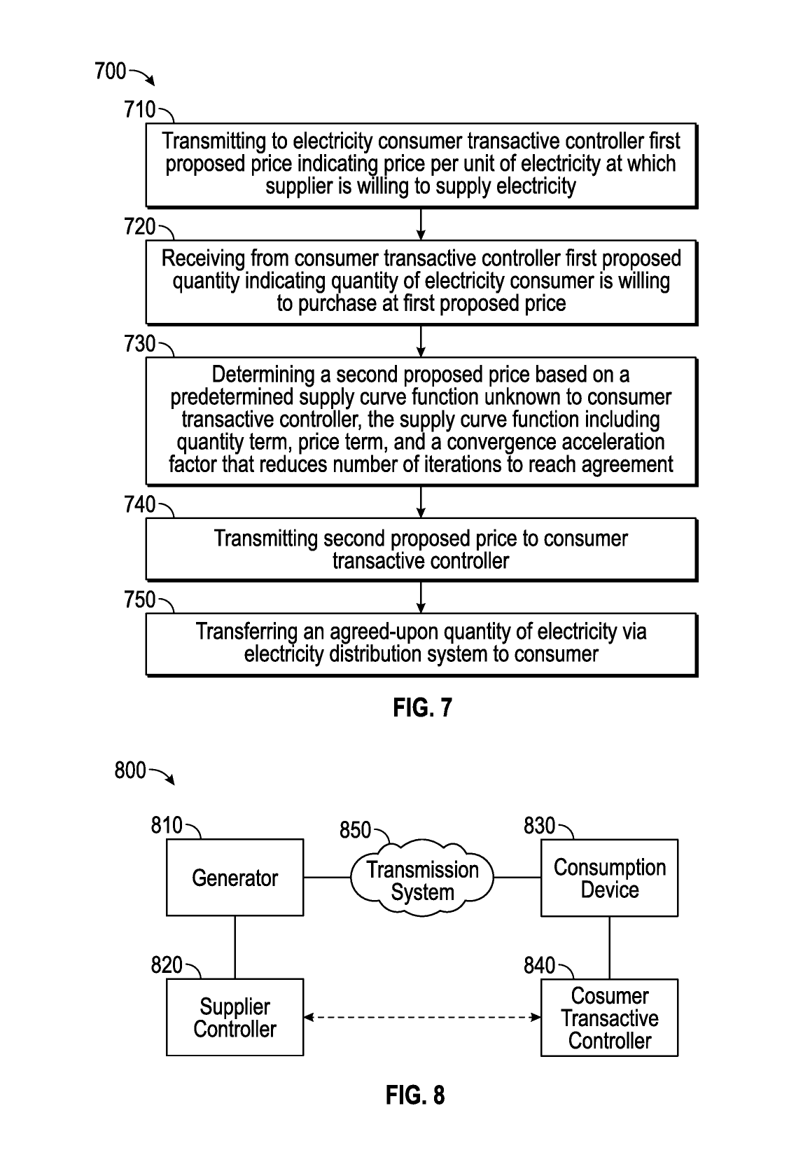

FIG. 7 illustrates an exemplary method 700 for auctionless negotiated price discovery using an accelerated convergence mechanism for facilitating electricity transactions in an electricity distribution system. The method 700 comprises (at 710) transmitting to an electricity consumer transactive controller a first proposed price indicating a price per unit of electricity at which an electricity supplier is willing to supply electricity; (at 720) receiving from the electricity consumer transactive controller a first proposed quantity indicating the quantity of electricity the electricity consumer is willing to purchase at the first proposed price, the first proposed quantity being determined based on a predetermined demand curve function unknown to the electricity supplier, the demand curve function including a term based on the first proposed price; (at 730) by computing hardware, determining a second proposed price indicating a price per unit of electricity at which the electricity supplier is willing to supply electricity, the second proposed price being based on a predetermined supply curve function unknown to the electricity consumer transactive controller, the supply curve function including a quantity term based on the first proposed quantity, a price term based on the first proposed price, and a convergence acceleration factor, wherein the convergence acceleration factor reduces a number of price and quantity proposal iterations between the electricity supplier and the electricity consumer transactive controller that are needed to reach agreement between the electricity consumer and the electricity supplier on an mutually acceptable price and quantity of electricity to transfer from the electricity supplier to the electricity consumer; (at 740) transmitting the second proposed price to the electricity consumer transactive controller; and (at 750) transferring an agreed-upon quantity of electricity via the electricity distribution system to the electricity consumer.

In some embodiments, the convergence acceleration factor causes the electricity consumer transactive controller and the electricity supplier to reach agreement on a mutually acceptable price and quantity of electricity to transfer from the electricity supplier to the electricity consumer within two price and quantity proposal iterations between the electricity supplier and the electricity consumer transactive controller. In some embodiments, the convergence acceleration factor comprises a price coefficient for the price term and a quantity coefficient for the quantity term. In some embodiments, “a” is greater than negative “b” where “a” is a slope of the supply curve and “b” is a slope of the demand curve. In some embodiments, the mutually acceptable price and quantity corresponds with an intersection of the supply curve and the demand curve. In some embodiments, the convergence acceleration factor is determined as a function of the supply curve, the first proposed price, and the first proposed quantity.

Other exemplary method can be performed from the consumer perspective. For example, some methods for auctionless negotiated price discovery using an accelerated convergence mechanism comprise: transmitting to an electricity supplier transactive controller a first proposed quantity indicating a quantity of electricity that an electricity consumer is willing to buy from an electricity supplier associated with the electricity supplier transactive controller; receiving from the electricity supplier transactive controller a first proposed price indicating a price per unit of electricity for which the electricity supplier is willing to supply the first proposed quantity of electricity to the electricity consumer, the first proposed price being determined based on a predetermined supply curve function unknown to the electricity consumer, the supply curve function including a term based on the first proposed quantity; by computing hardware, determining a second proposed quantity indicating a quantity of electricity that the electricity consumer is willing to buy from the electricity supplier, the second proposed quantity being based on a predetermined demand curve function unknown to the electricity supplier transactive controller, the demand curve function including a price term based on the first proposed price, a quantity term based on the first proposed quantity, and a convergence acceleration factor, wherein the convergence acceleration factor reduces a number of price and quantity proposal iterations between the electricity consumer and the electricity supplier transactive controller that are needed to reach agreement between the electricity supplier and the electricity consumer on an mutually acceptable price and quantity of electricity to transfer from the electricity supplier to the electricity consumer; transmitting the second proposed quantity to the electricity supplier transactive controller; and receiving an agreed-upon quantity of electricity via the electricity distribution system from the electricity supplier.

In some such methods, the convergence acceleration factor causes the electricity supplier transactive controller and the electricity consumer to reach agreement on a mutually acceptable price and quantity of electricity to transfer from the electricity supplier to the electricity consumer within two price and quantity proposal iterations between the electricity consumer and the electricity supplier transactive controller. In some embodiments, the convergence acceleration factor comprises a quantity coefficient for the quantity term and a price coefficient for the price term. In some embodiments, the mutually acceptable price and quantity corresponds with an intersection of the supply curve and the demand curve. In some embodiments, the convergence acceleration factor is determined as a function of the demand curve, the first proposed quantity, and the first proposed price. In some embodiments, one or more non-transitory computer-readable media can store computer-executable instructions which when executed by a computer cause the computer to perform the method 700 or any of its various embodiments or alternative methods discussed herein.

FIG. 8 shows a schematic diagram of an exemplary system 800 for facilitating electricity transactions using auctionless negotiated price discovery and an accelerated convergence mechanism. The system 800 comprises an electricity generator 810 associated with an electricity supplier, a supplier controller 820 associated with the electricity generator 810, an electricity consumption device 830 associated with an electricity consumer, a consumer transactive controller 840 associated with the electricity consumption device 830, and an electricity transmission system 850 that electrically couples the electricity generator and the electricity consumption device. The supplier controller 820 is configured to transmit (e.g., via the Internet, telephone lines, cell network, WiFi, LAN, or other wired or wireless communication system) to the consumer transactive controller 840 a first proposed price indicating a price per unit of electricity at which the electricity supplier is willing to supply electricity to the electricity consumer. The consumer transactive controller 840 is configured to transmit to the supplier controller 820 a first proposed quantity indicating a quantity of electricity the electricity consumer is willing to purchase at the first proposed price, the first proposed quantity being determined based on a predetermined demand curve function unknown to the electricity supplier, the demand curve function including a term based on the first proposed price. The supplier controller 820 is configured to determine a second proposed price indicating a price per unit of electricity at which the electricity supplier is willing to supply electricity to the electricity consumer, the second proposed price being based on a predetermined supply curve function unknown to the consumer transactive controller 840, the supply curve function including a quantity term based on the first proposed quantity, a price term based on the first proposed price, and a convergence acceleration factor, wherein the convergence acceleration factor reduces a number of price and quantity proposal iterations between the supplier controller 820 and the consumer transactive controller 840 that are needed to reach agreement between the electricity consumer and the electricity supplier on an mutually acceptable price and quantity of electricity to transfer from the electricity supplier to the electricity consumer. The supplier controller 820 is configured to then transmit or cause transmission of the determined second proposed price to the consumer transactive controller 840. The supplier controller 820 is configured to then cause an agreed-upon quantity of electricity to be transferred from the electricity generator 810 to the electricity consumption device 830 (or related energy handling devices) via the electricity transmission system 850).

In some embodiments, the convergence acceleration factor causes the consumer transactive controller and the supplier controller to reach agreement on a mutually acceptable price and quantity of electricity to transfer from the electricity supplier to the electricity consumer within two price and quantity proposal iterations between the supplier controller and the consumer transactive controller. In some embodiments, the convergence acceleration factor comprises a price coefficient for the price term and a quantity coefficient for the quantity term. In some embodiments, the mutually acceptable price and quantity corresponds with an intersection of the supply curve and the demand curve. In some embodiments, the convergence acceleration factor is determined as a function of the supply curve, the first proposed price, and the first proposed quantity.

### IV. Example Computing Environments

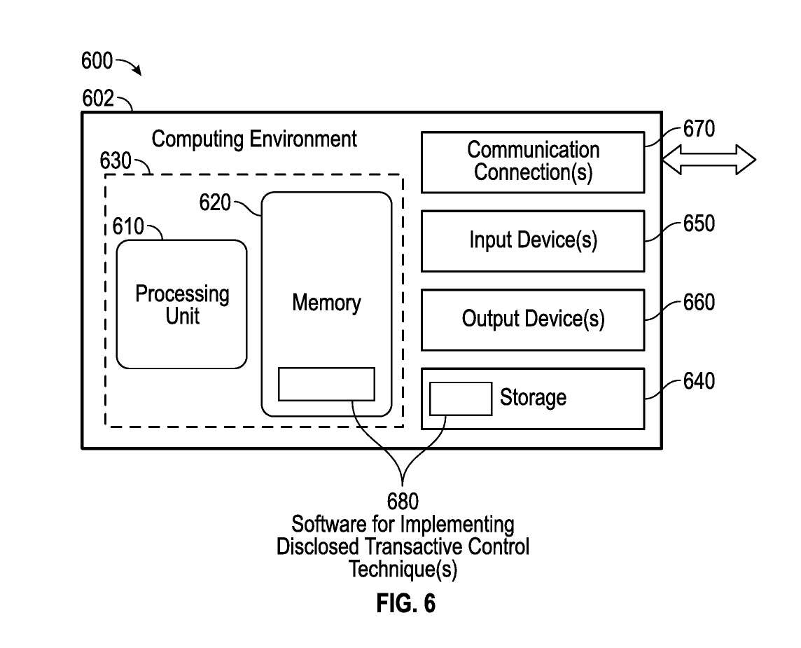

FIG. 6, illustrates a generalized example of suitable computing hardware 602 and computing environment 600 for a computing device with which several of the described embodiments can be implemented. The computing environment 600 is not intended to suggest any limitation as to the scope of use or functionality of the disclosed technology, as the techniques and tools described herein can be implemented in diverse general-purpose or special-purpose environments that have computing hardware.

With reference to FIG. 6, the computing hardware 602 and/or computing environment 600 includes at least one processing unit 610 and memory 620. In FIG. 6, this most basic configuration 630 is included within a dashed line. The processing unit 610 (e.g., a CPU, or other such processor) executes computer-executable instructions. In a multi-processing system, multiple processing units execute computer-executable instructions to increase processing power. The memory 620 may be volatile memory (e.g., registers, cache, RAM), non-volatile memory (e.g., ROM, EEPROM, flash memory), or some combination of the two. The memory 620 stores software 680 for implementing one or more of the described techniques for performing a demand-side (or a supply-side) transactive control strategy, or for controlling associated demand-side electrical devices/distributed assets (or supply-side electrical devices/distributed assets) in response thereto. For example, the memory 620 can store software 680 for implementing any of the disclosed techniques.

The computing environment can have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 can be removable or non-removable, and includes magnetic disks (e.g., hard drives), solid state drives (e.g., solid state drives based on flash memory), magnetic tapes or cassettes, CD-ROMs, DVDs, or any other tangible storage medium which can be used to store information in a non-transitory manner and which can be accessed within the computing environment 600. The storage 640 can also store instructions for the software 680 implementing any of the described techniques, systems, or environments.

The input device(s) 650 can be a touch input device such as a keyboard, mouse, touch screen, pen, or trackball, a voice input device, a scanning device, or another device that provides input to the computing environment 600. The output device(s) 660 can be a display, touch screen, printer, speaker, or another device that provides output from the computing environment 600.

The communication connection(s) 670 enable communication over a communication medium to another computing entity. The communication medium conveys information such as computer-executable instructions, an agent transport payload, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods, systems, and interfaces disclosed herein can be described in the general context of computer-executable instructions stored on one or more computer-readable media. Computer-readable media are any available media that can be accessed within or by a computing environment and do not encompass transitory carrier waves. Computer-readable media include tangible non-transitory computer-readable media, such as memory 620 and storage 640, and do not encompass propagating signals or carrier waves per se.

The various methods, systems, and interfaces disclosed herein can also be described in the general context of computer-executable instructions, such as those included in program modules, being executed in a computing environment on a target processor. Generally, program modules include routines, programs, libraries, objects, classes, components, data structures, and the like that perform particular tasks or implement particular abstract data types. The functionality of the program modules may be combined or split between program modules as desired in various embodiments. Computer-executable instructions for program modules may be executed within a local or distributed computing environment.

As noted, the disclosed technology can be implemented at least in part using a network of computing devices (e.g., any of the computing device examples described above). The network can be implemented at least in part as a Local Area Network (“LAN”) using wired networking (e.g., the Ethernet IEEE standard 802.3 or other appropriate standard) or wireless networking (e.g. one of the IEEE standards 802.11a, 802.11b, 802.11g, or 802.11n or other appropriate standard). Furthermore, at least part of the network can be the Internet or a similar public network.

### V. Concluding Remarks

Having illustrated and described the principles of the disclosed technology, it will be apparent to those skilled in the art that the disclosed embodiments can be modified in arrangement and detail without departing from such principles. For example, any one or more aspects of the disclosed technology can be applied in other embodiments. In view of the many possible embodiments to which the principles of the disclosed technologies can be applied, it should be recognized that the illustrated embodiments are only preferred examples of the technologies and should not be taken as limiting the scope of the disclosure. I claim all that comes within the scope of the following claims and their equivalents.

1. A method for auctionless negotiated price discovery using an accelerated convergence mechanism for facilitating electricity transactions in an electricity distribution system, the method comprising:
transmitting to an electricity consumer transactive controller a first proposed price indicating a price per unit of electricity at which an electricity supplier is willing to supply electricity;
receiving from the electricity consumer transactive controller a first proposed quantity indicating the quantity of electricity the electricity consumer is willing to purchase at the first proposed price, the first proposed quantity being determined based on a predetermined demand curve function unknown to the electricity supplier, the demand curve function including a term based on the first proposed price;
by computing hardware, determining a second proposed price indicating a price per unit of electricity at which the electricity supplier is willing to supply electricity, the second proposed price being based on a predetermined supply curve function unknown to the electricity consumer transactive controller, the supply curve function including a quantity term based on the first proposed quantity, a price term based on the first proposed price, and a convergence acceleration factor, wherein the convergence acceleration factor reduces a number of price and quantity proposal iterations between the electricity supplier and the electricity consumer transactive controller that are needed to reach agreement between the electricity consumer and the electricity supplier on an mutually acceptable price and quantity of electricity to transfer from the electricity supplier to the electricity consumer;
transmitting the second proposed price to the electricity consumer transactive controller; and
transferring an agreed-upon quantity of electricity via the electricity distribution system to the electricity consumer.

2. The method of claim 1, wherein the convergence acceleration factor causes the electricity consumer transactive controller and the electricity supplier to reach agreement on a mutually acceptable price and quantity of electricity to transfer from the electricity supplier to the electricity consumer within two price and quantity proposal iterations between the electricity supplier and the electricity consumer transactive controller.

3. The method of claim 1, wherein the convergence acceleration factor comprises a price coefficient for the price term and a quantity coefficient for the quantity term.

4. The method of claim 1, wherein “a” is a slope of the supply curve and “b” is a slope of the demand curve, and a is greater than −b.

5. The method of claim 1, wherein the mutually acceptable price and quantity corresponds with an intersection of the supply curve and the demand curve.

6. The method of claim 1, wherein the convergence acceleration factor is determined as a function of the supply curve, the first proposed price, and the first proposed quantity.

7. One or more non-transitory computer-readable media storing computer-executable instructions which when executed by a computer cause the computer to perform the method of claim 1.

8. A method for auctionless negotiated price discovery using an accelerated convergence mechanism for facilitating electricity transactions in an electricity distribution system, the method comprising:
transmitting to an electricity supplier transactive controller a first proposed quantity indicating a quantity of electricity that an electricity consumer is willing to buy from an electricity supplier associated with the electricity supplier transactive controller;
receiving from the electricity supplier transactive controller a first proposed price indicating a price per unit of electricity for which the electricity supplier is willing to supply the first proposed quantity of electricity to the electricity consumer, the first proposed price being determined based on a predetermined supply curve function unknown to the electricity consumer, the supply curve function including a term based on the first proposed quantity;
by computing hardware, determining a second proposed quantity indicating a quantity of electricity that the electricity consumer is willing to buy from the electricity supplier, the second proposed quantity being based on a predetermined demand curve function unknown to the electricity supplier transactive controller, the demand curve function including a price term based on the first proposed price, a quantity term based on the first proposed quantity, and a convergence acceleration factor, wherein the convergence acceleration factor reduces a number of price and quantity proposal iterations between the electricity consumer and the electricity supplier transactive controller that are needed to reach agreement between the electricity supplier and the electricity consumer on an mutually acceptable price and quantity of electricity to transfer from the electricity supplier to the electricity consumer;
transmitting the second proposed quantity to the electricity supplier transactive controller; and
receiving an agreed-upon quantity of electricity via the electricity distribution system from the electricity supplier.

9. The method of claim 8, wherein the convergence acceleration factor causes the electricity supplier transactive controller and the electricity consumer to reach agreement on a mutually acceptable price and quantity of electricity to transfer from the electricity supplier to the electricity consumer within two price and quantity proposal iterations between the electricity consumer and the electricity supplier transactive controller.

10. The method of claim 8, wherein the convergence acceleration factor comprises a quantity coefficient for the quantity term and a price coefficient for the price term.

11. The method of claim 8, wherein the mutually acceptable price and quantity corresponds with an intersection of the supply curve and the demand curve.

12. The method of claim 8, wherein the convergence acceleration factor is determined as a function of the demand curve, the first proposed quantity, and the first proposed price.

13. One or more non-transitory computer-readable media storing computer-executable instructions which when executed by a computer cause the computer to perform the method of claim 8.

14. A system for facilitating electricity transactions using auctionless negotiated price discovery and an accelerated convergence mechanism, the system comprising:
an electricity generator associated with an electricity supplier;
a supplier controller associated with the electricity generator;
an electricity consumption device associated with an electricity consumer;
a consumer transactive controller associated with the electricity consumption device; and
an electricity transmission system that electrically couples the electricity generator and the electricity consumption device;
wherein the supplier controller is configured to transmit to the consumer transactive controller a first proposed price indicating a price per unit of electricity at which the electricity supplier is willing to supply electricity to the electricity consumer;
wherein the consumer transactive controller is configured to transmit to the supplier controller a first proposed quantity indicating a quantity of electricity the electricity consumer is willing to purchase at the first proposed price, the first proposed quantity being determined based on a predetermined demand curve function unknown to the electricity supplier, the demand curve function including a term based on the first proposed price;
wherein the supplier controller is configured to determine a second proposed price indicating a price per unit of electricity at which the electricity supplier is willing to supply electricity to the electricity consumer, the second proposed price being based on a predetermined supply curve function unknown to the consumer transactive controller, the supply curve function including a quantity term based on the first proposed quantity, a price term based on the first proposed price, and a convergence acceleration factor, wherein the convergence acceleration factor reduces a number of price and quantity proposal iterations between the supplier controller and the consumer transactive controller that are needed to reach agreement between the electricity consumer and the electricity supplier on an mutually acceptable price and quantity of electricity to transfer from the electricity supplier to the electricity consumer;
wherein the supplier controller is configured to transmit the determined second proposed price to the consumer transactive controller; and
wherein the supplier controller is configured to cause an agreed-upon quantity of electricity to be transferred from the electricity generator to the electricity consumption device via the electricity transmission system.

15. The system of claim 14, wherein the convergence acceleration factor causes the consumer transactive controller and the supplier controller to reach agreement on a mutually acceptable price and quantity of electricity to transfer from the electricity supplier to the electricity consumer within two price and quantity proposal iterations between the supplier controller and the consumer transactive controller.

16. The system of claim 14, wherein the convergence acceleration factor comprises a price coefficient for the price term and a quantity coefficient for the quantity term.

17. The system of claim 14, wherein “a” is a slope of the supply curve and “b” is a slope of the demand curve, and a is greater than −b.

18. The system of claim 14, wherein the mutually acceptable price and quantity corresponds with an intersection of the supply curve and the demand curve.

19. The system of claim 14, wherein the convergence acceleration factor is determined as a function of the supply curve, the first proposed price, and the first proposed quantity.
